(19) United States
(12) Patent Application Publication
(10) Pub. No.: US 2025/0121589 A1
(43) Pub. Date: Apr. 17, 2025

(54) WINDOW PROTECTION SYSTEM

(71) Applicant: Safe Haven Defense US, LLC, Phoenix, AZ (US)

(72) Inventor: Steven Johnson, Phoenix, AZ (US)

(21) Appl. No.: 18/911,495

(22) Filed: Oct. 10, 2024

Related U.S. Application Data
(60) Provisional application No. 63/589,834, filed on Oct. 12, 2023.

(51) Int. Cl. B32B 17/10; B32B 7/12

(52) U.S. Cl. CPC B32B 17/10027; B32B 7/12; B32B 17/1055; B32B 17/10935; B32B 17/10981; B32B 2307/306; B32B 2307/54; B32B 2307/558; B32B 2307/7376; B32B 2307/748; B32B 2571/02

(57) ABSTRACT

Provided herein are projectile resistant glass treatment assemblies. The assemblies provide resistance to penetration of a glass pane by projectiles moving in a direction from the exterior to the interior of the glass pane.

### CROSS-REFERENCE TO RELATED APPLICATION

This application claims the benefit of priority to U.S. Provisional Patent Application No. 63/589,834, filed Oct. 12, 2023, which application is hereby incorporated by reference in its entirety.

### FIELD

This application relates generally to optically clear bullet resistant glass having a thickness of less than 1 inch, methods of making and uses thereof.

### BACKGROUND

A bulletproof glass assembly is composed of several elements, namely layers of colorless films (e.g., polyester films) laminated between layers of ordinary glass. Bulletproof glass is resistant to damage and penetration when impacted by a strong external force. These characteristics have led to wide application in various facilities and vehicles to protect human life or property.

One example of a bulletproof glass assemblies manufactured according to known techniques needs to have an overall thickness of greater than at least 1 inch to exhibit a bulletproof effect. In particular, in order to achieve a desired bulletproof effect, an overall thickness of greater than 35 mm (1.377 inches) or 45 mm (1.77 inches) is needed. This is because the physical properties of the glass layer, which is used as a main component of typical bulletproof glass, are very weak. To solve this drawback, bulletproof assemblies using synthetic resin component layers have been developed for use in place of glass having weak physical properties. Bulletproof panels using a synthetic resin component function by, inter alia, blocking impact of attack, blocking noise, providing thermal insulation, and blocking introduction of foreign substances and projectiles.

However, both the thickness of the glass elements and the synthetic resin elements result in a bulletproof assembly that does not have optical clarity and are impractical for retrofitting into existing window assemblies. In addition, due to the fact that the material itself constituting a typical bulletproof assembly is an opaque material, or that it is difficult to secure transparency due to frequent scratching even when a transparent material is used, these materials may be not suitable as materials for replacing a glass portion of a vehicle or a glass portion of an elevator.

Therefore, there is a demand for development of a transparent bullet resistant glass treatment system and assembly that can secure excellent bullet resistant performance, while providing overall assembly thinness and optical clarity, and that can be installed in the field (e.g., onto an existing pane of glass or window) while also providing noise blocking properties, thermal insulation improvement, and improved break and tensile strength. As the most commonly used glass pane in windows has a thickness of 0.25 inches, there is a need to strengthen (e.g., provide projectile resistance) for such windows.

### SUMMARY

The present application provides a transparent projectile resistant glass assembly comprising: a pane of glass with a thickness of about 0.25 to 1 inch; a single-ply film, wherein the single-ply film is adhered to an exterior surface of the glass; between one and six layers of a three-ply film laminate, wherein the three-ply film laminate is adhered to an interior surface of the glass; and whereby the glass assembly has a break strength starting at about 600 psi, a tensile strength of at least 30,000 psi, and an optical clarity of at least about 85%. In certain embodiments, the single-ply film is adhered to the exterior surface of the glass with a pressure sensitive mounting adhesive. In certain embodiments, the single-ply film comprises a pressure sensitive mounting adhesive. In certain embodiments, the three-ply film laminate is adhered to the interior surface of the glass with a pressure sensitive mounting adhesive. In certain embodiments, the three-ply film laminate comprises a pressure sensitive mounting adhesive. In certain embodiments, the pressure sensitive mounting adhesive provides a peel strength of about 6 psi to about 10 psi. In certain embodiments, the pane of glass has a thickness of about 0.25 inches. In certain embodiments, the pane of glass has a thickness of about 0.50 inches. In certain embodiments, the pane of glass has a thickness of about 0.75 inches.

In certain embodiments, wherein the single-ply film comprises polyethylene terephthalate (PET).

In certain embodiments, the interior surface comprises one layer of the three-ply film laminate. In certain embodiments, the exterior surface comprises one layer of the three-ply film laminate.

In certain embodiments, the pane of glass comprises treated glass. In certain embodiments, the pane of glass comprises untreated glass. In certain embodiments, the pane of glass comprises a window. In certain embodiments, the pane of glass comprises a single glass pane. In certain embodiments, the pane of glass comprises a double glass pane. In certain such embodiments, the double glass pane further comprises a layer of air between the two panes.

In certain embodiments, the projectile is a bullet. In certain such embodiments, the bullet is selected from the group consisting of plated bullets, full metal jacket bullets, lead bullets, round nose bullets, hollow-point bullets, boat tail bullets, pistol bullets, rifle bullets, armor-piercing bullets, soft point bullets, hunting bullets, heavy bullets, .38 special ammo, open tip bullets, close range bullets, and/or shot gun ammunition. In certain embodiments, the bullet has a projectile energy in the range of 215 foot pounds up to 2,600 foot pounds.

In certain embodiments, the glass assembly is characterized as meeting a ballistic standard for resistance of Underwriters Laboratories (UL) 752.

In certain embodiments, the glass assembly is further characterized by heat resistance or shatter resistance.

In certain embodiments, the glass assembly is in a building, an automobile, an airplane, and/or a bank teller kiosk. In certain such embodiments, the building is a residential building, commercial building, governmental building, school building, hospital building or other public facility.

The present application further provides a method of preparing a transparent projectile resistant glass assembly, comprising: applying to an exterior surface of a glass pane having a thickness of 0.25 to 1 inches a single-ply film adhered to the glass pane with a pressure sensitive mounting adhesive; applying between two to six layers of three-ply film laminate adhered to an inside surface of the glass pane with the pressure sensitive mounting adhesive; wherein the mounting adhesive provides a peel strength in the range of about 6 psi to about 10 psi; and wherein the transparent resistant glass pane has optical clarity and a break strength starting at about 600 psi and a tensile strength of at least 30,000 psi.

The present application further provides method of improving the optical clarity of a projectile resistant glass assembly comprising: applying to an exterior surface of a glass pane having a thickness of 0.25 to 1 inches a single-ply film with a pressure sensitive mounting adhesive; applying between one and six layers of three-ply film laminate adhered to an interior surface of the glass pane with the pressure sensitive mounting adhesive; wherein the mounting adhesive provides a peel strength in the range of about 6 psi to about 10 psi; and wherein the glass assembly has optical clarity in the range of 70% to 86%.

The present application also provides a method of preparing a projectile resistant window assembly comprising: applying to an exterior surface of a glass pane having a thickness of 0.25 to 1 inches a single-ply film with a pressure sensitive mounting adhesive; applying between three to eighteen layers of single-ply film comprising the pressure sensitive mounting adhesive to an inside surface of the glass pane; wherein the mounting adhesive provides a peel strength in the range of about 6 psi to about 10 psi; and wherein the transparent bullet resistant glass pane has optical clarity and a break strength starting at 600 psi and a tensile strength of at least 30,000 psi.

In certain embodiments of the methods of the present application, the glass pane (e.g., window) comprises a single glass pane. In other embodiments of the methods of the present application, the glass pane (e.g., window) comprises a double glass pane. In certain such embodiments, the double glass pane further comprises a layer of air between the two panes. In certain embodiments of the methods of the present application, the window assembly is a customized window. In certain embodiments of the methods of the present application, the method comprises retrofitting one or more existing glass pane(s) (e.g., windows).

In certain embodiments of the methods of the present application, the method further comprises cleaning the glass pane to remove any debris with a detergent. In certain such embodiments, the detergent comprises tomidol and tergitol.

In certain embodiments of the methods of the present application, the method further comprises curing the assembly for a period of less than one hour. In certain such embodiments, the method comprises curing the assembly for a period of about 5 to 15 minutes per layer.

In certain embodiments of the methods of the present application, the laminate layers are applied using a mounting tool comprising a squeegee or a hard press. In certain such embodiments, the hard press comprises a handle on one end, and a slotted opening on the other end that holds a rigid piece of plastic. In certain embodiments, the mounting tool transfers 50-80 lbs of pressure onto the three-ply film laminate.

In certain embodiments of the methods of the present application, the glass pane has a thickness of about 0.25 inches. In other embodiments of the methods of the present application, the glass pane has a thickness of about 0.50 inches. In still other embodiments of the methods of the present application, the glass pane has a thickness of about 0.75 inches.

In certain embodiments of the methods of the present application, the laminate comprises PET.

In certain embodiments of the methods of the present application, the optical clarity of the assembly is at least about 80%. In other embodiments of the methods of the present application, the optical clarity of the assembly is at least about 85%.

In certain embodiments of the methods of the present application, the glass pane comprises treated glass. In other embodiments of the methods of the present application, the glass pane comprises untreated glass.

In certain embodiments of the methods of the present application, the projectile is a bullet. In certain such embodiments, the bullet comprises lead core with a outer sleeve, such as an outer sleeve comprising copper, brass, cupronickel, steel or other metal. In certain embodiments, the bullet is selected from the group consisting of plated bullets, full metal jacket bullets, lead bullets, round nose bullets, hollow-point bullets, boat tail bullets, pistol bullets, rifle bullets, armor-piercing bullets, soft point bullets, hunting bullets, heavy bullets, .38 special ammo, open tip bullets, close range bullets, and/or shot gun ammunition. In certain embodiments, the bullet has a projectile energy in the range of 215 foot pounds up to 2,600 foot pounds.

In certain embodiments of the methods of the present application, the assembly is characterized as meeting a ballistic standard for resistance of Underwriters Laboratories (UL) 752.

In certain embodiments of the methods of the present application, the assembly is further characterized by heat resistance or shatter resistance.

In certain embodiments of the methods of the present application, the assembly is a component of a building, an automobile, an airplane, and/or a bank teller kiosk. In certain such embodiments, the building is a residential building, commercial building, hospital building, school building, or other public facility.

The present application further provides a transparent projectile resistant window assembly comprising: a pane of glass with a thickness of about 0.25 to 1 inch; a single-ply film, wherein the single-ply film is adhered to an exterior surface of the glass; between three to eighteen layers of single-ply polyethylene terephthalate film adhered to an interior surface of the glass; and whereby the window assembly provides a break strength starting at about 600 psi, a tensile strength of at least 30,000 psi, and an optical clarity of at least about 85%. In certain embodiments, the single-ply film is adhered to the exterior surface of the glass with a pressure sensitive mounting adhesive. In certain embodiments, the single-ply film comprises a pressure sensitive mounting adhesive. In certain embodiments, the between three to eighteen layers of single-ply polyethylene terephthalate film is adhered to the interior surface of the glass with a pressure sensitive mounting adhesive. In certain embodiments, the between three to eighteen layers of single-ply polyethylene terephthalate film comprises a pressure sensitive mounting adhesive. In certain embodiments, the pressure sensitive mounting adhesive provides a peel strength of about 6 psi to about 10 psi. In certain embodiments, the three to eighteen layers of single-ply polyethylene terephthalate film are adhered to each other with a pressure sensitive laminating adhesive.

In certain embodiments of the a transparent projectile resistant window assembly of the present application, the window comprises a single glass pane. In certain embodiments, the glass pane has a thickness of about 0.25 inches. In other embodiments, the glass pane has a thickness of about 0.50 inches. In still other embodiments, the glass pane has a thickness of about 0.75 inches.

In certain embodiments of the a transparent projectile resistant window assembly of the present application, the window assembly is a customized window.

In certain embodiments of the a transparent projectile resistant window assembly of the present application, the laminate comprises PET.

In certain embodiments of the a transparent projectile resistant window assembly of the present application, the optical clarity is at least about 87%.

In certain embodiments of the a transparent projectile resistant window assembly of the present application, the glass pane comprises treated glass. In other embodiments of the a transparent projectile resistant window assembly of the present application, the glass pane comprises untreated glass.

In certain embodiments of the a transparent projectile resistant window assembly of the present application, the projectile is a bullet. In certain such embodiments, the bullet comprises lead core with a outer sleeve, such as an outer sleeve comprising copper, brass, cupronickel, steel or other metal. In certain embodiments, the bullet is selected from the group consisting of plated bullets, full metal jacket bullets, lead bullets, round nose bullets, hollow-point bullets, boat tail bullets, pistol bullets, rifle bullets, armor-piercing bullets, soft point bullets, hunting bullets, heavy bullets, .38 special ammo, open tip bullets, close range bullets, and/or shot gun ammunition.

In certain embodiments of the a transparent projectile resistant window assembly of the present application, the bullet has a projectile energy in the range of 215 foot pounds up to 2,600 foot pounds. In certain embodiments of the a transparent projectile resistant window assembly of the present application, the assembly is characterized as meeting a ballistic standard for resistance of Underwriters Laboratories (UL) 752.

In certain embodiments of the a transparent projectile resistant window assembly of the present application, the assembly is further characterized by heat resistance or shatter resistance.

In certain embodiments of the a transparent projectile resistant window assembly of the present application, the assembly is in a building, an automobile, an airplane, and/or a bank teller kiosk. In certain such embodiments, the building is a residential building, commercial building, hospital building, school building, or other public facility.

### BRIEF DESCRIPTION OF THE DRAWINGS

FIG. 1 shows a side elevation view of a transparent bullet resistant glass treatment assembly of this application comprising a single pane of glass 102 with one layer of laminate 136 adhered to an exterior surface of the glass 152 and three layers of laminate 110, 118, and 126 adhered to an interior surface of the class 154.

FIG. 2 shows an expanded view of FIG. 1.

FIG. 3 shows a squeegee used to install the laminate layers to the glass panes to form the transparent bullet resistant glass treatment assembly of this disclosure.

### DETAILED DESCRIPTION

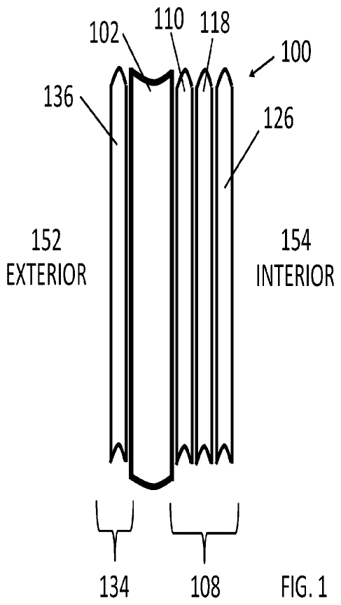

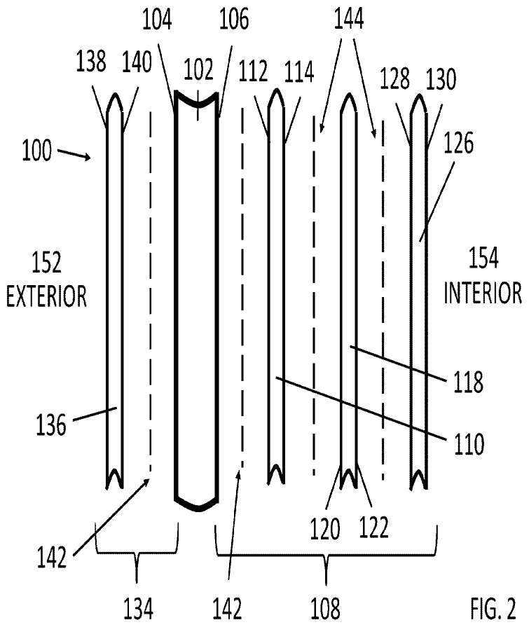

Referring to FIGS. 1-2, the present application provides a protection system 100 embodying aspects of the disclosed subject matter. The protection system 100 includes film layers (e.g., laminates comprising a pressure sensitive mounting adhesive) adhered to the exterior surface and interior surface of a glass pane 102 providing a projectile resistant glass treatment assembly having an increase in resistance to penetration of the glass pane 102 by projectiles moving in a direction from the exterior of the glass pane 102 to the interior of the glass pane 102.

Referring to FIG. 2, in certain embodiments, the protection system 100 comprises a glass pane 102 with a first surface 104 or exterior surface presented to an exterior 152 and an opposing second surface 106 or interior surface presented to an interior 154. An exterior film assembly 134 (e.g., a single-ply film comprising a pressure sensitive mounting adhesive) is adhered to the first surface 104, and a interior film assembly 108 (e.g., a three-ply film laminate comprising a pressure sensitive mounting adhesive or three single-ply films comprising pressure sensitive mounting adhesive between the individual single-ply films and a pressure sensitive mounting adhesive on the outside) is adhered to the second surface 106.

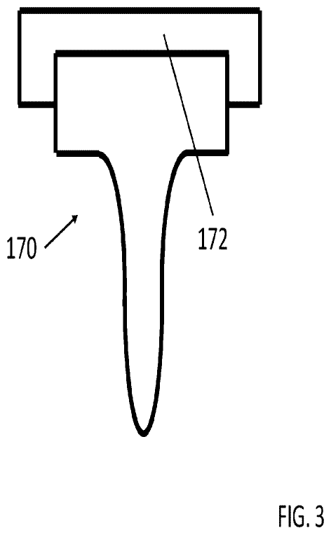

The exterior film assembly 134 may comprise one or more layers of single-ply film comprising a mounting adhesive (e.g., a pressure sensitive mounting adhesive). In certain embodiments, the exterior film assembly comprises a single-ply film 136 with a first surface 138 presenting to the exterior 152 and a second surface 140 presenting to the glass pane 102 first surface 104. A mounting adhesive (e.g., a pressure sensitive mounting adhesive) 142 at the second surface 140 adheres the exterior film assembly 134 to the first surface 104 of the glass pane 102. In certain embodiments, a squeegee 170 (FIG. 3) can be used to apply pressure upon the adhesive 42 by wiping the blade 172 across the first surface 138 while applying pressure to the squeegee. In certain embodiments, about 50-100, about 50-90, about 50-80, or about 50-70 pounds of pressure are imparted through the blade 172 onto the first surface 138. In certain embodiments, about 100 pounds of pressure are imparted through the blade 172 onto the first surface 138. The exterior film assembly 134 is adhered to glass pane 102 by drawing the blade 172 of the squeegee 170 across the single-ply film 136 working out any air that is trapped between the single-ply film 136 and glass pane 102 by moving the trapped air to the edges of the film layer. In certain embodiments, the squeegee of U.S. Pat. No. 2,123,638, incorporated herein by reference in its entirety, may be employed.

The interior film assembly 108 comprises two or more layers of single-ply film comprising an adhesive. In certain embodiments, the interior film assembly 108 comprises three layers of single-ply film comprising an adhesive (e.g., a three-ply film laminate comprising a mounting adhesive, such as a pressure-sensitive mounting adhesive, with a laminating adhesive, such as a pressure sensitive laminating adhesive, between each ply). In certain embodiments, the interior film assembly comprises one or more layers of three-ply film laminate. In certain embodiments, the interior film assembly comprises one layer of three-ply film laminate (e.g., three layers of single-ply film, wherein the three layers of single-ply film are adhered to one another with a laminating adhesive, such as a pressure sensitive laminating adhesive, between each ply). In certain embodiments, the interior film assembly comprises two layers of three-ply film laminate (e.g., six layers of single-ply film, wherein the six layers of single-ply film are adhered to one another with a laminating adhesive, such as a pressure sensitive laminating adhesive, between each ply). In certain embodiments, the interior film assembly comprises three layers of three-ply film laminate (e.g., nine layers of single-ply film, wherein the nine layers of single-ply film are adhered to one another with a laminating adhesive, such as a pressure sensitive laminating adhesive, between each ply). In certain embodiments, the interior film assembly comprises four layers of three-ply film laminate (e.g., twelve layers of single-ply film, wherein the twelve layers of single-ply film are adhered to one another with a laminating adhesive, such as a pressure sensitive laminating adhesive, between each ply). In certain embodiments, the interior film assembly comprises five layers of three-ply film laminate (e.g., fifteen layers of single-ply film, wherein the fifteen layers of single-ply film are adhered to one another with a laminating adhesive, such as a pressure sensitive laminating adhesive, between each ply). In certain embodiments, the interior film assembly comprises six layers of three-ply film laminate (e.g., eighteen layers of single-ply film, wherein the eighteen layers of single-ply film are adhered to one another with a laminating adhesive, such as a pressure sensitive laminating adhesive, between each ply). A single-ply film layer 110 has a first surface 112 presenting to the glass pane 102 second surface 106, a second single-ply film layer 118 has a first surface 120 presenting to the first single-ply film layer 110 second surface 114, and a third single-ply film layer 126 has a first surface 128 presenting to the second single-ply film layer 118 second surface 122 and a second surface 130 presenting to the interior 154. Laminating adhesive 144 (e.g., a pressure sensitive laminating adhesive) is used to adhere the single-ply film layers together. Laminating adhesive 144 between the first single-ply film layer 110 and second single-ply film layer 118, and laminating adhesive 144 between the second single-ply film layer 118 and third single-ply film layer 126 bond the single-ply film layers together to form the interior film assembly 108. Mounting adhesive 142 at the first single-ply film layer 110 first surface 112 adheres the interior film assembly 108 to the second surface 106 of the glass pane 102. The squeegee 170 can be used to apply pressure upon the adhesive 142 by wiping the blade 172 across the second surface 130 of the interior film assembly 108 using the technique to adhere the film assembly 134 as described above. In certain embodiments, about 50-100, about 50-90, about 50-80, or about 50-70 pounds of pressure are imparted through the blade 172 onto the second surface 130. In certain embodiments, about 100 pounds of pressure are imparted through the blade 172 onto the second surface 130. In certain embodiments, the cure time following application of each laminate layer is less than one hour. In certain embodiments, the cure time following application of each laminate layer is less than 30 minutes. In certain such embodiments, the cure time following application of each laminate layer is about 5-25 minutes, about 5-20 minutes, about 5-15 minutes, or about 5-10 minutes.

In certain embodiments, the projectile resistant glass treatment assembly of the present application has a break strength starting at about 600 psi, starting at about 700 psi, starting at about 800 psi, starting at about 900 psi, starting at about 1000 psi, starting at about 1100 psi, starting at about 1200 psi, starting at about 1300 psi, starting at about 1310 psi, starting at about 1320 psi, starting at about 1330 psi, starting at about 1340 psi, or starting at about 1350 psi. In certain embodiments, the projectile resistant glass treatment assembly of the present application has a break strength starting at about 1320 psi.

In certain embodiments, the projectile resistant glass treatment assembly of the present application has a tensile strength of at least about 10,000 psi, at least about 15,000 psi, at least about 20,000 psi, at least about 25,000 psi, at least about 26,000 psi, at least about 27,000 psi, at least about 28,000 psi, at least about 29,000 psi, at least about 30,000 psi, at least about 31,000 psi, at least about 32,000 psi, at least about 33,000 psi, at least about 34,000 psi, or at least about 35,000 psi. In certain embodiments, the projectile resistant glass treatment assembly of the present application has a tensile strength of at least 30,000 psi. In certain embodiments, the projectile resistant glass treatment assembly of the present application has a tensile strength of at least 31,000 psi. In certain embodiments, the projectile resistant glass treatment assembly of the present application has a tensile strength of at least 32,000 psi. In certain embodiments, the projectile resistant glass treatment assembly of the present application has a tensile strength of at least 33,000 psi. In certain embodiments, the projectile resistant glass treatment assembly of the present application has a tensile strength of at least 34,000 psi. In certain embodiments, the projectile resistant glass treatment assembly of the present application has a tensile strength of between about 30,000 psi and about 35,000 psi. In certain embodiments, the projectile resistant glass treatment assembly of the present application has a tensile strength of between about 31,000 psi and about 35,000 psi. In certain embodiments, the projectile resistant glass treatment assembly of the present application has a tensile strength of between about 32,000 psi and about 35,000 psi. In certain embodiments, the projectile resistant glass treatment assembly of the present application has a tensile strength of between about 33,000 psi and about 35,000 psi. In certain embodiments, the projectile resistant glass treatment assembly of the present application has a tensile strength of between about 34,000 psi and about 35,000 psi. In certain embodiments, the projectile resistant glass treatment assembly of the present application has a tensile strength of about 34,000 psi.

In certain embodiments, the projectile resistant glass treatment assembly of the present application has an improvement in the V₅₀ ballistic performance (where V₅₀ is the velocity at which a given projectile is expected to completely penetrate the material 50% of the time) of at least about 10%, at least about 20%, at least about 30%, at least about 40%, at least about 50%, at least about 55%, at least about 60%, at least about 65%, at least about 70%, at least about 75%, in comparison to the V₅₀ ballistic performance of the glass pane without the addition of the one or more single-ply film comprising a pressure sensitive mounting adhesive adhered to the exterior and interior surfaces of the glass.

In certain embodiments of the projectile resistant glass treatment assemblies of the present application, the glass treatment assembly comprises a window or glass door separating the exterior of a building from the interior of the building (e.g., of a residential building, such as a house, apartment, or condominium, or a commercial building, such as a retail store, a hospital, or a public safety facility), a partition (e.g., in a bank teller kiosk), a display case, protective eyewear, a shield (e.g., a face or body shield), or the window or windshield of a vehicle or an airplane. In certain embodiments of the foregoing, the projectile resistant glass treatment assembly of the present application is prepared or constructed using one or more pane(s) of glass already existing in any of the foregoing structures. For example, the single-ply film(s) comprising a mounting or laminating adhesive (e.g., a pressure sensitive mounting or laminating adhesive) as described herein are applied to one or more pane(s) of glass already existing in a window or glass door separating the exterior of a building from the interior of the building (e.g., of a residential building, such as a house, apartment, or condominium, or a commercial building, such as a retail store, a hospital, or a public safety facility), a partition (e.g., in a bank teller kiosk), a display case, protective eyewear, a shield (e.g., a face or body shield), or the window or windshield of a vehicle or an airplane, so that the projectile resistant glass treatment assembly of the present application is produced.

In certain embodiments of the projectile resistant glass treatment assembly of the present application, the projectile is a firearm projectile (e.g., one or more bullet(s)), projectile(s) from an explosive device, or projectiles from high wind velocity hurricanes. In certain embodiments, the projectile resistant glass treatment assembly of the present application provides resistance against projectiles (e.g., one or more bullet(s)) impacting at a minimum velocity of 320 m/s (1050 ft/s) or less, such as .22 caliber Long Rifle Lead Round Nose (LR LRN) bullets, with nominal masses of 2.6 g (40 gr). In certain embodiments, the projectile resistant glass treatment assembly of the present application provides resistance against projectiles (e.g., one or more bullet(s)) impacting at a minimum velocity of 312 m/s (1025 ft/s) or less, such as 380 ACP Full Metal Jacketed Round Nose (FMJ RN) bullets, with nominal masses of 6.2 g (95 gr), or 40 S&W caliber Full Metal Jacketed (FMJ) bullets, with nominal masses of 11.7 g (180 gr). In certain embodiments, the projectile resistant glass treatment assembly of the present application provides resistance against projectiles (e.g., one or more bullet(s)) impacting at a minimum velocity of 332 m/s (1090 ft/s) or less, such as 9 mm FMJ RN bullets, with nominal masses of 8.0 g (124 gr). In certain embodiments, the projectile resistant glass treatment assembly of the present application provides resistance against projectiles (e.g., one or more bullet(s)) impacting at a minimum velocity of 358 m/s (1175 ft/s) or less, such as 9 mm FMJ RN bullets, with nominal masses of 8.0 g (124 gr). In certain embodiments, the projectile resistant glass treatment assembly of the present application provides resistance against projectiles (e.g., one or more bullet(s)) impacting at a minimum velocity of 427 m/s (1400 ft/s) or less, such as 357 Magnum Jacketed Soft Point (JSP) bullets, with nominal masses of 10.2 g (158 gr); 9 mm FMJ RN bullets, with nominal masses of 8.0 g (124 gr); or 44 Magnum Semi Jacketed Hollow Point (SJHP) bullets, with nominal masses of 15.6 g (240 gr). In certain embodiments, the projectile resistant glass treatment assembly of the present application provides resistance against projectiles (e.g., one or more bullet(s)) impacting at a minimum velocity of 838 m/s (2750 ft/s) or less, such as 7.62 mm FMJ bullets (U.S. Military designation M80), with nominal masses of 9.6 g (148 gr). In certain embodiments, the projectile resistant glass treatment assembly of the present application provides resistance against projectiles (e.g., one or more bullet(s)) impacting at a minimum velocity of 869 m/s (2850 ft/s) or less, such as .30 caliber armor piercing (AP) bullets (U.S. Military designation M2 AP), with nominal masses of 10.8 g (166 gr).

In certain embodiments, the projectile resistant glass treatment assembly of the present application provides resistance against one or more projectiles (e.g., one or more bullets comprising a soft lead core covered by a copper, brass, cupronickel, steel or other metal outer sleeve. In certain embodiments, the projectile resistant glass treatment assembly of the present application provides resistance against one or more bullet(s), wherein the bullet comprises a FMJ bullet (e.g., a bullet comprising a lead core completely covered, except for the base, with copper alloy (approximately 90% copper and 10% zinc)), a jacketed hollow point (JHP) bullet (e.g., a bullet comprising a lead core which has a hollow cavity or hole located in the nose of the bullet and is completely covered except for the hollow point with a copper alloy (approximately 90% copper and 10% zinc) jacket), a JSP bullet (e.g., a lead bullet, also known as a Semi Jacketed Soft Point (SJSP), completely covered, except for the point, with copper alloy (approximately 90% copper and 10% zinc) jacket), a lead bullet (e.g., a bullet made entirely of lead, which may be alloyed with hardening agents), a round nose bullet (e.g., a bullet with a blunt or rounded nose), a SJHP bullet (e.g., a bullet consisting of a lead core with a copper alloy (approximately 90% copper and 10% zinc) jacket covering the base and bore riding surface (major diameter), which leaves some portion of the lead core exposed, thus forming a lead nose or tip, which has a hollow cavity or hole located in the nose or tip of the bullet), or a SJSP bullet (e.g., a bullet consisting of a lead core with a copper alloy (approximately 90% copper and 10% zinc) jacket covering the base and bore riding surface (major diameter), which leaves some portion of the lead core exposed, thus forming a lead nose or tip). A bullet comprises a kinetic projectile that is a component of firearm ammunition that is shot from a gun barrel. Bullets may be made in a variety of materials, such as for example copper, lead, steel, polymer, rubber and even wax; and are made in various shapes and constructions (depending on the intended applications), including specialized functions such as hunting, target shooting, training, and combat. Bullets may be tapered, making them more aerodynamic. Bullet sizes are typically expressed by weight and diameter (referred to as “caliber”). Typically, bullets do not normally contain explosives but strike or damage the intended target by transferring kinetic energy upon impact and penetration. Bullets can have different uses and a specific bullet may have a more specific application, such as for example, hunting, self-defense, target practice etc.

Certain types of bullets are described below:

Plated bullets are a middle ground between lead and jacketed bullets and are ideal for shooting at indoor ranges.

Full metal jacket bullets consist of a hard outer shell and a soft metal inner, such as a soft lead core. These are bullets that are ideal for increased accuracy. The hard outer metal cover protects the soft inner lead from melting too quickly. These improve a bullet's trajectory and are ideal for handguns and rifles.

Lead bullets may be used for most shooting applications. There are state bans on the use of lead bullets for hunting due to the toxic nature of lead. Lead bullets are common at gun ranges, for target shooting or practicing.

Round nose bullets has a tip that is ½ the diameter of the bullet. The tip is rounded, not hollow, and differs from those bullets with pointed tips, such as some options for rifle shells. Round nose bullets provide deeper penetration than other types of bullets, such as flat-nose bullets. Round-nosed bullets are good for target practice, pest control, and self-defense.

Hollow-point bullets are useful when control of damage and penetration of the bullet is important. They are used in tactical situations where the bullet's trajectory cannot leave the target—hostage situations, in-home defense, self-defense, etc. Outside tactical situations, hollow-point bullets are useful for target practice in view of their accuracy.

Boat tail bullets are useful in situations where precision is a must. They comprise a tapered tip that adds stability to the trajectory once the bullet leaves the barrel. With an increase in its coefficient, the tip of the bullet stays elevated longer making it ideal for target practice, sniping, and long-distance shooting.

Rifle bullets are typically longer than those for handguns. They have more powder, and their larger diameter means they have a a greater velocity. Rifle bullets come in numerous formats including: semi-jacketed, full metal jacket, jacketed hollow points, lead or lead round nose, and they have a number of differing applications such as hunting, sniping, distance target practice and competition.

Armor-piercing bullets are typically used against targets wearing ballistic armors. They are also useful against ballistic shields which would cause an average bullet to deflect or stop before hitting the target. Armor-piercing bullets may be used with handguns and/or rifles and are not legal in all states.

Soft point bullets are a replacement bullet for hunting in situations for big game targets. Many hunters use soft point bullets in situations where a hollow point bullet is not permitted.

Hunting bullets comprise numerous types of ammunition. They range from big-bore bullets for rifles to shotgun shells. The goal of hunting bullets is to prevent as much damage to the carcass as possible. Since hunting takes on many aspects including gathering furs or pelts, sustenance hunting, and population control, different types of hunting bullets are better suited for the different goals of hunting.

Heavy bullets are slower than light-weight bullets making them prone to the forces of gravity. A heavy bullet is typically useful in for big game hunting, especially at close range. These penetrate deeply.

.38 Special ammo is popular for home and self-defense situations. It is slightly larger than a 9 mm bullet.

Open tip bullets (OTB)/match bullets are generally used at shooting events and for target practice. They can be used for hunting and competitively. OTB is prized for competitions because they are more accurate than many other types of bullets, such as rounded-tip bullets. The small open pit at the bullet's head expands keeping the tip of the bullet from drooping during its trajectory. OTB is one form of hollow-point bullets.

Law enforcement bullets are tactical bullets often with a hollow point and may include armor-piercing applications.

Close-range bullets are typically suitable for handguns since handguns fire at a lower velocity and do not make very good long-range weapons. Handguns are generally good in the zero to 50-yard range.

Shotgun ammunition come in an array of sizes and differ from bullets that have a metal casing and instead have baskets that hold the shot. Shotguns are close-range weapons and can be useful in self-defense.

In certain embodiments, the projectile resistant glass treatment assembly of the present application provides resistance against one or more bullet(s), wherein the one or more bullet(s) has a projectile energy of from about 150 foot-pounds to about 3,000 foot-pounds, from about 175 foot-pounds to about 2,900 foot-pounds, from about 200 foot-pounds to about 2,800 foot-pounds, from about 210 foot-pounds to about 2,700 foot-pounds, or about from about 215 foot-pounds to about 2,600 foot-pounds. In certain embodiments, the projectile resistant glass treatment assembly of the present application provides resistance against one or more bullet(s), wherein the one or more bullet(s) has a projectile energy of up to about 3,000 foot-pounds, up to about 2,900 foot-pounds, up to about 2,800 foot-pounds, up to about 2,700 foot-pounds, up to about 2,600 foot-pounds, up to about 2,500 foot-pounds up to about 2,000 foot-pounds, up to about 1,500 foot-pounds, up to about 1,250 foot-pounds, up to about 1,000 foot-pounds, up to about 750 foot-pounds, up to about 500 foot-pounds, up to about 400 foot-pounds, up to about 300 foot-pounds, up to about 275 foot-pounds, up to about 250 foot-pounds, up to about 225 foot-pounds, or up to about 200 foot-pounds.

In certain embodiments of the present application, the projectile resistant glass pane assembly of the present application would be classified as bullet resistant in accordance with U.S. National Institute of Justice's Standard for Ballistic Resistant Protective Materials 0108.01, European Committee for Standardization EN 1063, and/or Euronorm standard for Bullet Resistance in Windows, Doors, Shutters and Blinds EN 1522. In certain such embodiments, the projectile resistant glass pane assembly of the present application is bullet resistant without splintering. For example, in certain embodiments of the present application, the projectile resistant glass pane assembly of the present application would be classified as Type I bullet resistant (e.g., resistant to one or more bullets from a 22 Long Rifle or 38 Special) in accordance with U.S. National Institute of Justice's Standard for Ballistic Resistant Protective Materials 0108.01. In certain embodiments of the present application, the projectile resistant glass pane assembly of the present application would be classified as Type II-A bullet resistant (e.g., resistant to one or more bullets from a lower velocity 375 Magnum or a 9 mm in addition to those listed for Type I above) in accordance with U.S. National Institute of Justice's Standard for Ballistic Resistant Protective Materials 0108.01. In certain embodiments of the present application, the projectile resistant glass pane assembly of the present application would be classified as Type II bullet resistant (e.g., resistant to one or more bullets from a higher velocity 375 Magnum or a 9 mm in addition to those listed for Type I and II-A above) in accordance with U.S. National Institute of Justice's Standard for Ballistic Resistant Protective Materials 0108.01. In certain embodiments of the present application, the projectile resistant glass pane assembly of the present application would be classified as Type III-A bullet resistant (e.g., resistant to one or more bullets from a 44 Magnum or a Submachine Gun 9 mm in addition to those listed for Type I, II-A, and II above) in accordance with U.S. National Institute of Justice's Standard for Ballistic Resistant Protective Materials 0108.01. In certain embodiments of the present application, the projectile resistant glass pane assembly of the present application would be classified as Type III bullet resistant (e.g., resistant to one or more bullets from a high powered rifle in addition to those listed for Type I, II-A, II, and III-A above) in accordance with U.S. National Institute of Justice's Standard for Ballistic Resistant Protective Materials 0108.01. In certain embodiments of the present application, the projectile resistant glass pane assembly of the present application would be classified as Type IV bullet resistant (e.g., resistant to one or more bullets from an armor-piercing rifle in addition to those listed for Type I, II-A, II, III-A, and III above) in accordance with U.S. National Institute of Justice's Standard for Ballistic Resistant Protective Materials 0108.01.

In certain embodiments of the present application, the projectile resistant glass pane assembly of the present application would be classified as bullet resistant in accordance with Underwriters Laboratories Standard UL 752. The Underwriters Laboratories (UL) 752 standard is a rating system for the ballistic resistance of building components, such as glass and plastic products. The standard is used to test and certify the ability of these materials to withstand armed attacks. Specifically, Level 1 Rating provides protection from small caliber handguns up to 9 mm and is often used for gas stations, transactions windows, retail/convenience stores, and pharmacies. Level 2 Rating provides protection from large caliber handguns up to .357 magnum and is commonly used in financial institution such as banks, credit unions, and check cashing businesses. Level 3 Rating provides protection from large bore, large caliber handguns up to .44 magnum and is frequently specified in high-risk and high-occupancy public buildings, including school and government facilities as well as law enforcement, courthouse, and prisons. Levels 4-8 Ratings provide protection against automatic weapons, assault rifles, and large caliber rifles. Levels 4-8 are normally only used in embassies, government facilities, and military applications.

The ratings for levels of bullet resistant glass are calculated by the protection the glass offers, based on the number of rounds fired before it breaks as well as the size of the weapon used. For example, UL 752 Level 3 provides protection against three shots of a 240-grain 44 Magnum Lead Semi-Wadcutter Gas Checked at an feet per second (fps) between 1350 and 1485. UL 752 Level 4 provides protection against one shot of a 180-grain .30 caliber rifle lead core soft point at an fps between 2540 and 2794. The projectiles fired by high-caliber, high-velocity weapons deliver the greatest amount of force to the target. This requires higher bullet resistant glass levels, which indicate a higher capacity for absorbing energy from the projectile. To be at the highest bullet proof glass levels, the entirety of the system-including the glazing material, frame and anchors-must be capable of absorbing the force from the projectiles.

In certain embodiments of the projectile resistant glass pane assembly of the present application, the glass pane assembly resists penetration of one or more projectiles, such as more than two, three, four, or five projectiles. In certain embodiments of the projectile resistant glass pane assembly of the present application, the glass pane assembly resists movement of the projectile in a first direction (e.g., from the exterior to the interior) while allowing movement of a projectile in a second direction (e.g., from the interior to the exterior). In certain such embodiments, the glass pane assembly resists movement of one or more projectiles in a first direction even after allowing multiple projectiles to penetrate in the second direction.

In certain embodiments, the single-ply film (i.e., 136 in FIG. 2) is manufactured from any suitable polymer such as ethylene vinyl acetates (EVA), ethylene acrylic acid (EAA) copolymers, ethylene-methacrylic acid (EMA) copolymers, polymeric ionomers, polyethylenes, including low density polyethylene (LDPE), very low density polyethylenes (VLDPE), ultra-low density polyethylenes (ULDPE), polyethylene copolymerized with olefins such as butene, hexene or octene, acid- or maleic anhydride-modified polyethylene, polypropylene (PP), acid- or maleic anhydride-modified PP, PP copolymers, including copolymers with olefin monomers, polyester polymers, such as polyethylene terephthalate (PET), polyester copolymers, such as PET copolymers, amorphous polyesters, polystyrene, polyurethanes, copolyesters, polyvinyl butyral (PVB), polyacrylates, including thermal and UV curable acrylic resins and polymethyl-methacrylate (PMMA), PMMA copolymers, cyclic olefin copolymers (COC), polyamides, polyamide copolymers, polybutylene terephthalate (PBT), polycarbonates (PC), polyether-imides (PEI), and polyethersulfones (PES). In certain embodiments, the single-ply film (i.e., 136 in FIG. 2) is manufactured from polyethylene terephthalate (PET).

In certain embodiments, the single-ply film of the present application further comprises one or more additive(s), such as a heat stabilizer, UV absorber, UV stabilizer, colorant, nucleators and/or clarifiers. In certain such embodiments, addition of the one or more additive(s) serves to reduce and/or eliminate yellowing that may otherwise occur from sun exposure, thereby providing improvements in optical performance of the projectile resistant glass assemblies of the present application. In other such embodiments, addition of the one or more additive(s) serves to absorb UV radiation, thereby reducing damage to the skin and/or eyes. UV absorbers include, without limitation, octabenzone, bumetrizole, hydroxyphenyl triazine, hydroxylphenyl benzotriazole and titanium oxide. UV stabilizers can trap free radicals that are formed from UV radiation-induced photodegradation processes in the film laminate. UV stabilizers include, without limitation, benzophenones, benzoate, tetramethyl-4-piperidinyl stearate and benzotriazole. Nucleators and clarifiers include, without limitation, aromatic carboxylic salts (e.g. sodium benzonate), talc, dibenzylidene sorbitol (DBS), sorbitol acetals, organophosphate salts, norbonane carboxylic acid salt, and the like.

In certain embodiments, the pressure-sensitive mounting adhesive (i.e., 142 in FIG. 2) or pressure-sensitive adhesive (PSA), typically comprises a nonreactive adhesive which forms a bond when pressure is applied to bond the adhesive with a surface. No solvent, water, or heat is needed to activate the adhesive. It is used in pressure-sensitive tapes, labels, glue dots, stickers, sticky note pads, automobile trim, and a wide variety of other products. As the name “pressure-sensitive” indicates, the degree of bond is influenced by the amount of pressure which is used to apply the adhesive to the surface. Surface factors such as smoothness, surface energy, removal of contaminants, etc. are also important to proper bonding. PSAs form a bond simply by the application of light pressure to marry the adhesive with the adherend. Pressure-sensitive adhesives are designed with a balance between flow and resistance to flow. The bond forms because the adhesive is soft enough to flow, or wet, the adherend. The bond has strength because the adhesive is hard enough to resist flow when stress is applied to the bond. Once the adhesive and the adherend are in proximity, there are also molecular interactions such as van der Waals forces involved in the bond, which contribute significantly to the ultimate bond strength. PSAs exhibit viscoelastic (viscous and elastic) properties, both of which are used for proper bonding. In contrast with structural adhesives, whose strength is evaluated as lap shear strength, pressure-sensitive adhesives are characterized by their shear and peel resistance as well as their initial tack. These properties are dependent, among other things, on the formulation, coating thickness, rub-down and temperature. “Permanent” pressure-sensitive adhesives are initially pressure-sensitive and removable but after hours or days change their properties, by becoming less or not viscous, or by increasing the bond strength, so that the bond becomes permanent. In certain embodiments, the adhesive (e.g., pressure-sensitive adhesive) may be a copolymer comprising an acrylate polymer and a silicone macromer. In some embodiments, an adhesive layer thickness may be about 10 to about 100 microns, about 12 to about 75 microns, about 25 to about 38 microns, about 30 microns, or about 35 microns. The pressure-sensitive adhesive may comprise an acrylate-silicone copolymer based pressure-sensitive adhesive. In some embodiments, the adhesive layer is made of an adhesive that does not immediately firmly secure the single-ply film to the glass or another single-ply film but instead allows for slight repositionability after placement. For example, the adhesive layer may include an amount of silicone to permit repositionability. In some embodiments, unpolymerized silicone, tackifier, or other low molecular weight components are included in the adhesive layer and migrate into the single-ply film and modify its characteristics. A single-ply film comprising an adhesive layer may be made more impact resistant by the interaction with one or more such components from an adhesive. In some embodiments, the adhesive layer comprises a polyacrylate-based pressure-sensitive adhesive layer, having silicone macromer side chain modifications of one or more acrylate ester groups. In some embodiments, the adhesive layer may be prepared from or comprise acrylic acid, methacrylic acid, esters of acrylic acid comprising 4 to 21 carbon atoms, esters of methacrylic acid comprising 5 to 21 carbon atoms, acrylamide, substituted acrylamides such as N,N-dimethyl acrylamide, styrene, substituted styrenes such as vinyl toluene, acrylonitrile, methacrylonitrile, N-vinyl pyrrolidone, N-vinyl caprolactam, vinylidene chloride, vinyl esters of carboxylic acids, 2-(2-ethoxyethoxy)ethyl acrylate, 2-ethylhexyl acrylate, butyl acrylate, hydroxyethyl acrylate, hydroxypropyl acrylate, 2-carboxyethyl acrylate, ethoxyethyl acrylate, perfluorooctyl acrylate, isooctyl acrylate, divinylbenzene, vinylbenzyl chloride, vinyl acetate, glycidyl methacylate, hydroethyl acetate, hydroxypropyl acetate, glacial acrylic acid, methyl acrylate, ethyl acrylate, butyl acrylate, iso butyl acrylate or other acrylates, or combinations thereof. In some embodiments, the pressure-sensitive adhesive comprises acrylate and silicone in other polymer configurations as known in the art. Suitable pressure-sensitive adhesives may be manufactured by 3M Company of St. Paul, Minn. or other manufacturing companies. In certain embodiments, the pressure-sensitive adhesive may further comprise one or more additive(s) that are not contrary to the object of the present application. In certain such embodiments, the one or more additive(s) may be selected from the group consisting of: flame retardants, photopolymerization initiators, antistatic agents, surfactants, leveling agents, thixotropy-imparting agents, anti-fouling agents, printability improvers, antioxidants, weather resistance stabilizers, light resistance stabilizers, ultraviolet absorbers, heat stabilizers, pigments, and fillers. The amount of the optional additive(s) may be, for example, about 0.01 to 10 parts by mass based of the pressure-sensitive adhesive.

In certain embodiments, the pressure-sensitive adhesive provides a peel strength of from about 5 psi to about 10 psi, from about 6 psi to about 10 psi, from about 6 psi to about 9 psi, from about 6 psi to about 8 psi, or from about 6 psi to about 7 psi. In certain embodiments, the pressure-sensitive mounting adhesive provides a peel strength of from about 6 psi to about 10 psi. In certain embodiments, the pressure-sensitive adhesive provides a peel strength of about 5 psi, about 6 psi, about 7 psi, about 8 psi, about 9 psi, or about 10 psi. In certain embodiments, the pressure-sensitive laminating adhesive provides a peel strength of about 10 psi.

In certain embodiments, the projectile resistant glass treatment assembly of the present application is transparent and/or optically clear. In certain embodiments, the projectile resistant glass treatment assembly of the present application has transmittance in the visible spectral range of at least 20%, at least 50%, or at least 70%. In certain embodiments, each component of the projectile resistant glass treatment assembly of the present application (e.g., the pane of glass and the single-ply PET film comprising a pressure sensitive mounting adhesive) has transmittance in the visible spectral range of at least 20%, at least 50%, or at least 70%. In certain embodiments, the projectile resistant glass treatment assembly of the present application has an optical clarity of at least about 70% meaning the projectile resistant glass treatment assembly of the present application is transparent to at least 70% of the visible spectral range. In certain embodiments, the projectile resistant glass treatment assembly of the present application has an optical clarity of at least about 70%, at least about 71%, at least about 72%, at least about 73%, at least about 74%, at least about 75%, at least about 76%, at least about 77%, at least about 78%, at least about 79%, at least about 80%, at least about 81%, at least about 82%, at least about 83%, at least about 84%, at least about 85%, at least about 86%, at least about 87%, at least about 88%, at least about 89%, at least about 90%, at least about 91%, at least about 92%, at least about 93%, at least about 94%, or at least about 95%. In certain embodiments, the projectile resistant glass treatment assembly of the present application has an optical clarity of at least about 85%. In certain embodiments, each component of the projectile resistant glass treatment assembly of the present application (e.g., the pane of glass and the single-ply PET film comprising a pressure sensitive mounting adhesive) is transparent and/or optically clear. In certain embodiments, each component of the projectile resistant glass treatment assembly of the present application (e.g., the pane of glass and the single-ply PET film comprising a pressure sensitive mounting adhesive) has an optical clarity of at least about 70%, at least about 71%, at least about 72%, at least about 73%, at least about 74%, at least about 75%, at least about 76%, at least about 77%, at least about 78%, at least about 79%, at least about 80%, at least about 81%, at least about 82%, at least about 83%, at least about 84%, at least about 85%, at least about 86%, at least about 87%, at least about 88%, at least about 89%, at least about 90%, at least about 91%, at least about 92%, at least about 93%, at least about 94%, or at least about 95%. In certain embodiments, each component of the projectile resistant glass treatment assembly of the present application (e.g., the pane of glass and the single-ply PET film comprising a pressure sensitive mounting adhesive) has an optical clarity of at least about 85%. In certain embodiments, the projectile resistant glass treatment assembly of the present application has low haze. In certain embodiments, each component of the projectile resistant glass treatment assembly of the present application (e.g., the pane of glass and the single-ply PET film comprising a pressure sensitive mounting adhesive) has low haze. The luminous transmittance, opacity and haze of embodiments of the present application can be assessed readily by one of skill in the art. For example, embodiments may be measured using a TCS Plus Spectrophotometer.

In certain embodiments, the glass pane(s) are constructed from at least one glass selected from the group consisting of flat glass, float glass, quartz glass, borosilicate glass, soda lime glass, aluminosilicate glass, a lithium aluminosilicate glass, and ceramic glass. In certain embodiments, the glass pane(s) are constructed from soda lime glass. In certain embodiments, the thickness of each individual glass pane is at least about 6 mm, such as from about 6 mm to about 25 mm, from about 6 mm to about 19 mm, or from about 6 mm to about 13 mm. In certain embodiments, the thickness of each individual glass pane is from about 6 mm to about 13 mm. In certain embodiments, the thickness of each individual glass pane is at least about 0.25 inches, such as from about 0.25 inches to about 1.0 inches, from about 0.25 inches to about 0.75 inches, from about 0.25 inches to about 0.5 inches, or from about 0.5 inches to about 0.75 inches. In certain embodiments, the thickness of each individual glass pane is about 0.25 inches. In certain embodiments, the thickness of each individual glass pane is about ⅜ inches. In certain embodiments, the thickness of each individual glass pane is about 0.50 inches. In certain embodiments, the thickness of each individual glass pane is about 0.75 inches.

In certain embodiments of the present application, the projectile (e.g., bullet) resistant glass pane assembly is prepared by cleaning the glass pane to remove any debris. In certain embodiments of the present application, the bullet resistant glass pane assembly is prepared by cleaning the glass pane with detergent to remove any debris. In certain such embodiments, the detergent comprises one or more nonionic surfactants. In certain such embodiments, the detergent comprises a first nonionic surfactant comprising a linear primary C11-C15 alcohol ethoxylates, including those which have from about 3 to about 10 moles of ethoxylation. For example, the detergent comprises a first nonionic surfactant comprising a linear C9-11 alcohol with 2.7 moles (average) of ethylene oxide (e.g., a Tomadol product such as Tomadol 91-2.5). In certain embodiments, the detergent comprises between about 50-75% of the first nonionic surfactant, such as about 55-70%, about 60-70%, about 65-70%, or about 65%, 66%, 67%, 68%, 69%, or 70% of the first nonionic surfactant. In certain embodiments, the detergent comprises about 66% of the first nonionic surfactant (e.g., a Tomadol product such as Tomadol 91-2.5). In certain embodiments, the detergent comprises as second nonionic surfactant based on a primary alcohol ethoxylate initiated by a C9-11 alcohol and ethoxylated with an average of 6 mol ethylene oxide (e.g., a Tergitol product such as Tergitol 91-6). In certain embodiments, the detergent comprises between about 1-25% of the second nonionic surfactant, such as about 5-25%, about 10-25%, about 15-20%, or about 15%, 15.5%, 16%, 16.5%, 17%, 17.5%, 18%, 18.5%, 19%, 19.5% or 20% of the second nonionic surfactant. In certain embodiments, the detergent comprises about 16.5% of the second nonionic surfactant (e.g., a Tergitol product such as Tergitol 91-6).

In certain embodiments of the present application, the projectile (e.g., bullet) resistant glass pane assembly is prepared by cleaning the glass pane to remove any debris at temperatures below freezing (i.e., below 0° C.). In certain such embodiments, the bullet resistant glass pane assembly is prepared by cleaning the glass pane with detergent that is functional at temperatures below 0° C. (e.g., that comprises antifreeze such that it remains in the liquid phase and does not freeze). In certain embodiments, the detergent solution comprises any suitable antifreeze, such as at least about 16 oz alcohol (e.g., methanol, ethanol, ethylene glycol) per gallon of water. In certain embodiments, antifreeze comprises an additive which lowers the freezing point of a water-based liquid. In certain embodiments, antifreeze comprises a mixture used to achieve freezing-point depression for cold environments. In certain such embodiments, the antifreeze also increases the boiling point of the liquid, allowing higher coolant temperature. In certain embodiments, the antifreeze comprises additives with lower heat capacities than water, thereby reducing water's ability to act as a coolant when added to it. Low molecular weight organic compounds tend to have melting points lower than water, which makes them suitable for use as antifreeze agents. In certain embodiments, the antifreeze agent comprises an alcohol (e.g., methanol, ethanol, ethylene glycol, etc.) in water.

Unless defined otherwise, all technical and scientific terms have the same meaning as is commonly understood by one of ordinary skill in the art to which the embodiments disclosed belongs. Certain terms are discussed below or elsewhere in the specification to provide additional guidance to the practitioner in describing the compositions and methods of the disclosure and how to make and use them. The scope or meaning of any use of a term will be apparent from the specific context in which it is used.

As used herein, the terms “a” or “an” means that “at least one” or “one or more” unless the context clearly indicates otherwise.

As used herein, the term “about” means that the numerical value is approximate and small variations would not significantly affect the practice of the disclosed embodiments. Where a numerical limitation is used, unless indicated otherwise by the context, “about” means the numerical value can vary by +10% and remain within the scope of the disclosed embodiments.

As used herein, the term “treated glass” or “tempered glass” includes glass that has been heat-processed e.g., through a tempering furnace, or chemically processed to alter its strength characteristics. Treated glass may provide greater resistance to thermal and mechanical stresses as compared to untreated (i.e., annealed) glass.

As used herein, the term “untreated glass” or “annealed glass” refers to glass that has not been heat-strengthened.

### EXAMPLES

The following examples are offered to illustrate but not to limit the application.

### Example 1: Ballistics Test

The projectile resistance of embodiments of the present application can be assessed using standard methods and classified in accordance with standard practice, such as in accordance with U.S. National Institute of Justice's Standard for Ballistic Resistant Protective Materials 0108.01, European Committee for Standardization EN 1063, and/or Euronorm standard for Bullet Resistance in Windows, Doors, Shutters and Blinds EN 1522. The following is a typical procedure that can be performed for such an assessment.

The ammunition used for the investigation can be any standard ammunition, including, for example, 124 grain (8 g) 9 mm Luger FMJ RN, minimum velocity 1305 feet per second (fps) (398 m/s).

Tests can be conducted at close range, approximately 15 ft (4.6 m), using the ammunition and weapon specified. The test samples are mounted in a rigidly fixed frame, with 0.001 in. (0.0254 mm) thick aluminum foil sheet placed approximately 18 in. (467 mm) behind the protected side of each test sample. During the test, each bullet velocity is monitored and recorded.

The samples are subjected to three different shot patterns: 1-shot edge, 2-shot and 3-shot.

The 1-shot edge pattern consists of mounting a sample in a frame with the lower edge unsupported and struck with a single shot placed midway between the vertical supports and 1 to 1½ in. (25.4 to 38.1 mm) from the unsupported edge.

The 2-shot pattern consists of two shots fired at the approximate center of the test sample, with the shots spaced between 1¼ to 1¾ in. (31.8 to 44.5 mm) apart. For both the single-shot and 2-shot pattern, spalling of bullet-resisting material from the protected side of the test sample is acceptable. However, there shall be no penetration of the projectile through the material such that damage to the indicator panels occurs, nor breaking apart of the sample which allows an unobstructed path for additional projectiles through the sample.

The 3-shot pattern consists of three shots spaced 4±½ in. (102±12.7 mm) apart in a triangular pattern in the approximate center of the test sample. With this shot pattern, there shall be no penetration of projectiles through the test sample, nor spalling of the material on the protected side of the test sample, to the extent that fragments embed in or damage the indicators.

For an indoor assessment, the sample is conditioned at 20±5.6° C. (68±10° F.) for 3 hours. The velocity of each bullet is recorded during the test. The velocity values as recorded for multiple shot tests consist of the first value of the 2-shot pattern being the top point, and the second being the bottom point, the first value of the 3-shot pattern is the top point of the triangle, with the next values going in a clockwise direction around the triangle. Results from the testing, including construction review, can then be used to provide the assessment and classification.

### Example 2: Projectile Resistance Ratings

Projectile resistant glass pane assemblies of the present application can be assessed and characterized in accordance with the classification systems described above. Particular assemblies and their classifications are provided in the table below. For each assembly tested, one single-ply film was adhered to the exterior surface of the glass pane(s). Various numbers of layers of three-ply film laminate were adhered to the interior surface of the glass. Row 1 of Table 1 provides the type of glass being tested, and column 2 provides the lab standard against which it is being tested. Each table entry provides the number of layers of three-ply film laminate adhered to the interior surface of the glass and the resulting maximum break strength of the interior plies. For example, 4 layers of three-ply film laminate was adhered to the interior surface of a ¼ inch pane of glass which had one single-ply film adhered to the exterior surface of the glass pane, and a maximum break strength of 2,640 PSI was measured when tested using the lab standard NIJ 1 .38 Special.

TABLE 1
Window Assembly Testing Results

| | | | Dual Pane | | | 1/4″ Air | 1/2″ Air |
|---|---|---|---|---|---|---|---|
| | Pane | 1/4″ | 1/4″ | 3/8″ | 1/2″ | 1/2″ | 1/2″ |
| National | NIJ 1.38 | 4 | 3 | 2 | 1 | 1 | 1 |
| Institute | Special | 2,640 PSI | 1,980 PSI | 1320 PSI | 660 PSI | 660 PSI | 660 PSI |
| of Justice | NIJ 2 .357 | — | 4 | 5 | 3 | 1 | 1 |
| (NIJ) | Magnum | | 2,640 PSI | 3,300 PSI | 1,980 PSI | 660 PSI | 660 PSI |
| | 9 mm | | | | | | |
| | NIJ 3A .44 | — | — | — | — | 6 | — |
| | Mag | | | | | 3,960 PSI | |
| | NIJ 3 AK-47 | — | — | — | — | 5 | 3 |
| | | | | | | 3,300 PSI | 1,980 PSI |
| Underwriter | UL 1 9 mm | — | 3 | 4 | 2 | 1 | 1 |
| Laboratories | | | 1,980 PSI | 2,640 PSI | 1,320 PSI | 660 PSI | 660 PSI |
| (UL) | UL2 .357 Mag | — | 4 | 5 | 3 | 2 | 1 |
| | 9 mm | | 2,640 PSI | 3,300 PSI | 1,980 PSI | 1,320 PSI | 660 PSI |
| | UL3 .44 Mag | — | — | — | — | 6 | 3 |
| | | | | | | 3,960 PSI | 1,980 PSI |
| | UL4 | — | — | — | — | — | — |
| | UL5 .308 Nato | — | — | — | — | 6 | 5 |
| | | | | | | 3,960 PSI | 3,300 PSI |
| | UL6 | — | 4 | 5 | 3 | 2 | 1 |
| | 9 mm MP5 | | 2,640 PSI | 3,300 PSI | 1,980 PSI | 1,320 PSI | 660 PSI |
| | UL7 .223/5.56 | — | — | — | — | 5 | 3 |
| | | | | | | 3,300 PSI | 1,980 PSI |

### Example 3: Projectile Resistance Test for Commercially Available Window Systems

The penetration resistance of a third party commerically available 18×18 inch glass window assembly of 0.334 inch thickness and 7.998 lbs weight was tested against threat level 1 using the test specifications set forth in UL 752, 11th Edition. Specifically, a first shot of a Remington 9 mm 124 gr. FMJ (23558) with velocity of 1201 ft/s penetrated the glass system.

While preferred embodiments of the present application have been shown and described herein, it will be apparent to those skilled in the art that such embodiments are provided by way of example only. Numerous variations, changes, and substitutions will now occur to those skilled in the art without departing from the application. It should be understood that various alternatives to the embodiments of the application described herein may be employed in practicing the application. It is intended that the following claims define the scope of the application and that methods and embodiments within the scope of these claims and their equivalents be covered thereby.

### INCORPORATION BY REFERENCE

All references cited in this application, and their references, are incorporated by reference herein in their entirety where appropriate for teachings of additional or alternative details, features, and/or technical background.

1. A transparent projectile resistant glass assembly, comprising:
a pane of glass with a thickness of about 0.25 to 1 inch;
a single-ply film, wherein the single-ply film is adhered to an exterior surface of the glass;
between one and six layers of a three-ply film laminate, wherein the three-ply film laminate is adhered to an interior surface of the glass; and
whereby the glass assembly has a break strength starting at about 600 psi, a tensile strength of at least 30,000 psi, and an optical clarity of at least about 85%.

2. The glass assembly of claim 1, wherein the single-ply film is adhered to the exterior surface of the glass with a pressure sensitive mounting adhesive.

3. (canceled)

4. The glass assembly of claim 1, wherein the three-ply film laminate is adhered to the interior surface of the glass with a pressure sensitive mounting adhesive.

5. (canceled)

6. The glass assembly of claim 2, wherein the pressure sensitive mounting adhesive provides a peel strength of about 6 psi to about 10 psi.

7-8. (canceled)

9. The glass assembly of claim 1, wherein the pane of glass has a thickness of about 0.75 inches.

10. (canceled)

11. The glass assembly of claim 1, wherein one layer of a three-ply film laminate is adhered to the interior surface of the glass.

12-13. (canceled)

14. The glass assembly of claim 1, wherein the projectile is a bullet.

15-16. (canceled)

17. The glass assembly of claim 1, wherein the glass assembly is characterized as meeting a ballistic standard for resistance of Underwriters Laboratories 752.

18. The glass assembly of claim 1, wherein the glass assembly is further characterized by heat resistance or shatter resistance.

19-20. (canceled)

21. The glass assembly of claim 1, wherein the pane of glass comprises a window.

22-26. (canceled)

27. A method of preparing a projectile resistant window assembly, comprising:
applying to an exterior surface of a glass pane having a thickness of 0.25 to 1 inches a single-ply film with a pressure sensitive mounting adhesive;
applying between three to eighteen layers of a single-ply film comprising the pressure sensitive mounting adhesive to an inside surface of the glass pane;
wherein the mounting adhesive provides a peel strength in the range of about 6 psi to about 10 psi; and
wherein the window assembly has an optical clarity and a break strength starting at 600 psi and a tensile strength of at least 30,000 psi.

28-31. (canceled)

32. The method of claim 27, wherein the method comprises retrofitting one or more existing glass pane(s).

33. The method of claim 27, wherein the method further comprises cleaning the glass pane to remove any debris with a detergent.

34. (canceled)

35. The method of claim 27, wherein the method further comprises curing the assembly for a period of less than one hour.

36. The method of claim 27, wherein the method further comprises curing the assembly for a period of about 5 to 15 minutes per layer.

37. The method of claim 27, wherein the laminate layers are applied using a mounting tool comprising a squeegee or a hard press.

38-41. (canceled)

42. The method of claim 27, wherein the glass pane has a thickness of about 0.75 inches.

43. (canceled)

44. The method of claim 27, wherein the optical clarity of the assembly is at least about 80%.

45-47. (canceled)

48. The method of claim 27, wherein the projectile is a bullet.

49-52. (canceled)

53. The method of claim 27, wherein the assembly is characterized as meeting a ballistic standard for resistance of Underwriters Laboratories 752.

54. The method of claim 27, wherein the assembly is further characterized by heat resistance or shatter resistance.

55-56. (canceled)

57. A transparent projectile resistant window assembly, comprising:
a pane of glass with a thickness of about 0.25 to 1 inch;
a single-ply film, wherein the single-ply film is adhered to an exterior surface of the glass;
between three to eighteen layers of single-ply polyethylene terephthalate film adhered to an interior surface of the glass; and
whereby the window assembly provides a break strength starting at about 600 psi, a tensile strength of at least 30,000 psi, and an optical clarity of at least about 85%.

58. (canceled)

59. The window assembly of claim 57, wherein the single-ply film is adhered to the exterior surface of the glass with a pressure sensitive mounting adhesive.

60. (canceled)

61. The window assembly of claim 57, wherein the between three to eighteen layers of single-ply film laminate is adhered to the interior surface of the glass with a pressure sensitive mounting adhesive.

62. (canceled)

63. The window assembly of claim 61, wherein the pressure sensitive mounting adhesive provides a peel strength of about 6 psi to about 10 psi.

64-67. (canceled)

68. The window assembly of claim 57, wherein the pane of glass has a thickness of about 0.75 inches.

69. (canceled)

70. The window assembly of claim 57, wherein the optical clarity is at least about 80%.

71-73. (canceled)

74. The window assembly of claim 57, wherein the projectile is a bullet.

75-78. (canceled)

79. The window assembly of claim 57, wherein the window assembly is characterized as meeting a ballistic standard for resistance of Underwriters Laboratories 752.

80. The window assembly of claim 57, wherein the window assembly is further characterized by heat resistance or shatter resistance.

81-82. (canceled)
